(19) United States
(12) Patent Application Publication
(10) Pub. No.: US 2011/0106329 A1
(43) Pub. Date: May 5, 2011

(54) METHODS AND APPARATUS FOR CHARGING STATION WITH SMS USER INTERFACE

(75) Inventors: Richard B. Donnelly, Austin, TX (US); Bradford J. Claflin, Austin, TX (US); Kenneth W. Thomas, Austin, TX (US)

(73) Assignee: GRIDbot, LLC, Austin, TX (US)

(21) Appl. No.: 12/938,259

(22) Filed: Nov. 2, 2010

Related U.S. Application Data
(60) Provisional application No. 61/257,758, filed on Nov. 3, 2009.

(51) Int. Cl. H02J 7/32; G06F 1/26

(52) U.S. Cl. 700/291; 320/109; 700/295

(57) ABSTRACT

A charging station, together with methods and systems, for charging the batteries of plug-in vehicles may be controlled with a mobile communications terminal via SMS text messages and provides an availability prediction system. One more charging stations with charging modules or ports are connected to a power source and to a control server. The control server communicates to a prospective user by text message an estimate of how long a given available charging port will remain available. A charging station with charging ports in use communicates to a prospective user that the port will be available at a particular time. Advantageous features provide hybrid switches to reduce the risk of arcing when a charging cord is unplugged for a port, demand response to modulate current draw from the power source based on usage conditions, power cord protection, illuminated user interface with ambient light sensitive illumination level, and charging ports for level one and level two charging.

### CROSS REFERENCE TO RELATED APPLICATIONS

This disclosure is related to, claims priority from and incorporates by reference the disclosure of provisional patent application Ser. No. 61/257,758, filed Nov. 3, 2009 and entitled METHODS AND APPARATUS FOR CHARGING STATION WITH SMS USER INTERFACE.

### TECHNICAL FIELD

The present disclosure relates to electric vehicle charging stations and in particular to shared charging stations that communicate wirelessly with the customer to provide a charging station availability prediction system.

### BACKGROUND

A vehicle that uses batteries and an electric motor(s) as a primary means of propulsion is often called an electric vehicles or “EV.” An EV that can be plugged-in to an off-board source of energy to charge up its batteries is commonly referred to as a Plug-in Electric Vehicle. Plug-in Electric Vehicles include: Battery (only) highway capable electric vehicles or “BEVs”; plug-in hybrid electric vehicles or “PHEVs”; neighborhood electric vehicles restricted in speed for non highway use or NEVs; and personal electric vehicles or “PEVs” like scooters, motorcycles, Segways, For the purposes of this disclosure, EVs, BEVs, PHEVs, PEVs and other vehicles having one or more rechargeable battery as a power source to move the vehicle may be referred to generally as plug-in vehicles or EVs.

Plug-in vehicles are a growing segment of vehicular traffic. Accordingly, municipalities and commercial establishments have recognized the need to service such vehicles with public charging stations. For example, a person may drive their plug-in vehicle to a Movie Theater or restaurant where they park the vehicle and may wish to charge the vehicle while it is parked by connecting it to an external electric power source near the parking spot. Similarly, a person may park at a municipal parking spot that requires payment to a parking meter and the person may want to top off the vehicle's batteries while it is parked by connecting the vehicle to an external electric power source.

Accordingly, it would be beneficial for the operator of a plug-in vehicle to know when a charging station is, available, and for how long it will be available, and to have that information communicated by the charging station to the customer's mobile phone or communications terminal.

### SUMMARY

To address the concerns mentioned above, a charging station, together with methods and systems, is disclosed herein for charging the batteries of Plug-in vehicles. The charging station may be controlled with a mobile communications terminal, such as a mobile phone via SMS text messages and provides an availability prediction system. One more charging, stations with charging modules or ports are connected to a power source and to a control server. The control server communicates to a prospective user by text message an estimate of how long a given available charging port will remain available. A charging station with charging ports in use communicates to a prospective user that the port will be available at a particular time.

Advantageous features provide hybrid switches to reduce the risk of arcing when a charging cord is unplugged for a port, demand response to modulate current draw from the power source based on usage conditions, power cord protection, illuminated user interface with ambient light sensitive illumination level, and charging ports for level one and level two charging.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 is a diagrammatic illustration of a specific exemplary embodiment of plug-in vehicle charging system and Charging-Station Availability System of the present disclosure.

FIG. 2 illustrates a specific exemplary embodiment of a CAP system of FIG. 1.

FIG. 3 is a transparent side view of a specific exemplary embodiment of an assembled charging station of the present disclosure.

FIG. 4 is an exploded front view of a user interface of a charging station of the present disclosure.

FIG. 5 is an exemplary embodiment of a process flow diagram for an SMS interface of a CAP system of the embodiment of FIG. 1.

FIG. 6 is a process flow diagram of SMS behavior remapping for an exemplary embodiment of a CAP system of the present disclosure.

FIG. 7 is a diagrammatic illustration of an exemplary alternative embodiment of a charging station system and CAP system of the present disclosure.

FIG. 8 is a diagrammatic illustration of the electronic components of an exemplary embodiment of a station of the present disclosure.

FIG. 9 shows circuit diagrams of an exemplary embodiment of a hybrid switching circuit of a station of the present disclosure.

FIG. 10 is a circuit diagram of an exemplary embodiment of a fast hybrid switching circuit of a station of the present disclosure.

FIG. 11 is a circuit diagram of an alternative safety circuit of the present disclosure.

FIG. 12 is a diagrammatic illustration of an exemplary Modular Charging Port Scheme of the present disclosure.

FIG. 13 is a circuit diagram of an exemplary embodiment of a door locking circuit for a charging module of the present disclosure.

FIG. 14 is a diagrammatic illustration of an automatic dimming feature for a user interface of the present disclosure.

FIG. 15 is a diagrammatic illustration of a station user interface of a charging station of the present disclosure.

FIG. 16 is a diagrammatic illustration of various modules for a CAP system of the present disclosure.

FIG. 17 is a schematic diagram illustrating the physical components of an exemplary embodiment of a charging station of the present disclosure.

FIG. 18 is a diagrammatic illustration of an exemplary embodiment of a door locking mechanism of a charging station of the present disclosure.

FIG. 19 is a side view illustration of an exemplary embodiment of a hinged housing access of a charging station of the present disclosure.

FIG. 20 is an illustration of a cable strain relief device of a charging station of the present disclosure.

FIG. 21 is a side view illustration of tiled modules of a charging station of the present disclosure.

### DETAILED DESCRIPTION

Definitions that may be useful for the understanding of this disclosure include:

GSM/Cellular Network mean the global network of mobile communication devices.

Mobile Data Network means networks over which data is communicated and includes networks known as GPRS, 3G, 4G and the like.

Mobile Phone means any mobile phone that can provide voice or SMS communication with the global mobile network.

Communications terminals means any device capable of sending and receiving communications by voice or data, including without limitation mobile phones, smart phones, PDAs, laptop computers, desktop computers and the like.

For the purposes of this disclosure, the terms charging module or charging port may be used interchangeably.

### Embodiment 1

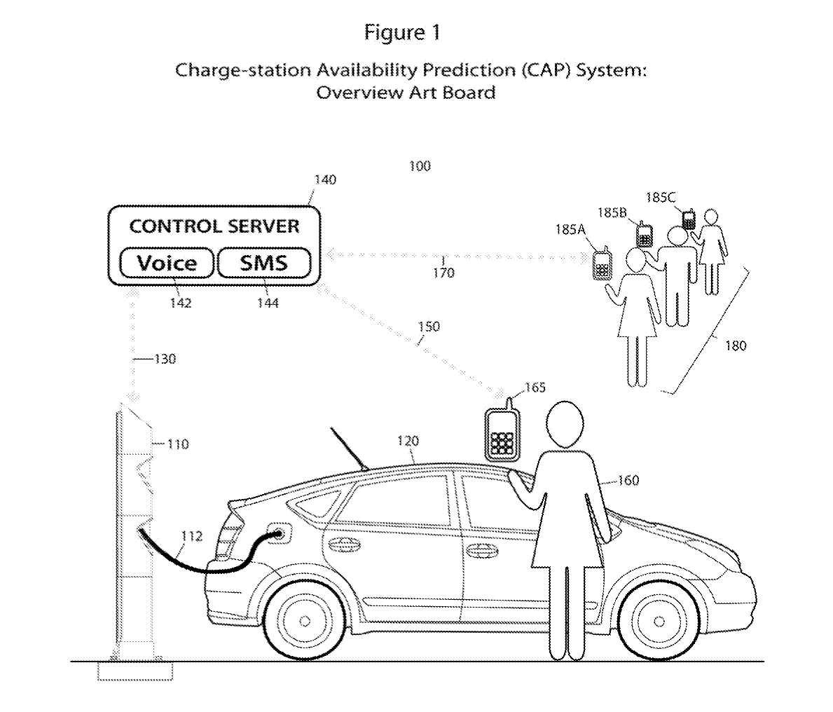

FIG. 1 is a diagrammatic illustration of a specific exemplary embodiment of plug-in vehicle charging system and Charging-Station Availability System of the present disclosure. Referring to FIG. 1, the reference numeral 100 generally designates a charging station system embodying features of the present disclosure. The Charge-Station Availability Prediction (“CAP”) system 100 includes a charging station 110 connected 112 to plug-in vehicle 120. Station 110 communicates 130 with control server 140. Control server 140 is a centralized control and logging center for the CAP system and manages voice services 142 and SMS services 144. These services 142,144 communicate 150 via a telephone network or the Internet with user 160 through her mobile phone or other suitable device 165. The services 142, 144 may also communicate 170 with other potential users 180 regarding the time a charging station 110 will become available through their respective mobile phones 185A, B, and C.

Specific exemplary embodiments of control server 140 may include the following components: a Logging Database that logs availability data as well as real-time and historical charging data useful to the user; a User Authentication and Security server that facilitates the verification of users subscription permitting them to use the charging services offered at the station; and a Backend interface Component that allows for the management of users and mining of user and station data.

The system 100 depicted in FIG. 1 may be referred to as the Charge-Station Availability Prediction (CAP) System of the present disclosure. A feature of specific exemplary embodiments of the CAP system is the text message, also sometimes referred to as TXT message, interface between a user 160, 165 and the charging station network 110. The receipt and transmission of text messages with a mobile phone typically requires access to an SMS services provider, where SMS refers to Short Message Service.

Any number of users 180 that have a mobile phone 185A-C capable of receiving TXT messages can interact with a charge station 110 of the present disclosure. The TXT message (or alternative voice message) is used to start charging their plug-in vehicle 120 for a specific period that the user requests. The user's 160 station use information is held in the memory of the control server 140 so that when other users 180 query the charging station 110 with their phone 185A-C about the station's availability to charge their vehicle, the charging station 110 is able to respond in real time, which allows the other users 180 to predict when next the station 110 will be available to charge their vehicle.

Station 110 employs, in certain specific embodiments, a combination of sensors and communication modalities such that station 110 remains powered off until a vehicle 120 is connected to it, and then to power on after communicating 150 information to control server 140. Control server 140 manages communication with current user 160 and other potential users 180 via their respective mobile devices. Control server 140 also controls the power on and off of station 110 and the time period to be powered on. Control server 140 powers on station 110 after control server 140 confirms that vehicle 120 is plugged in properly to station 110 and has authenticated user 160 with her phone number.

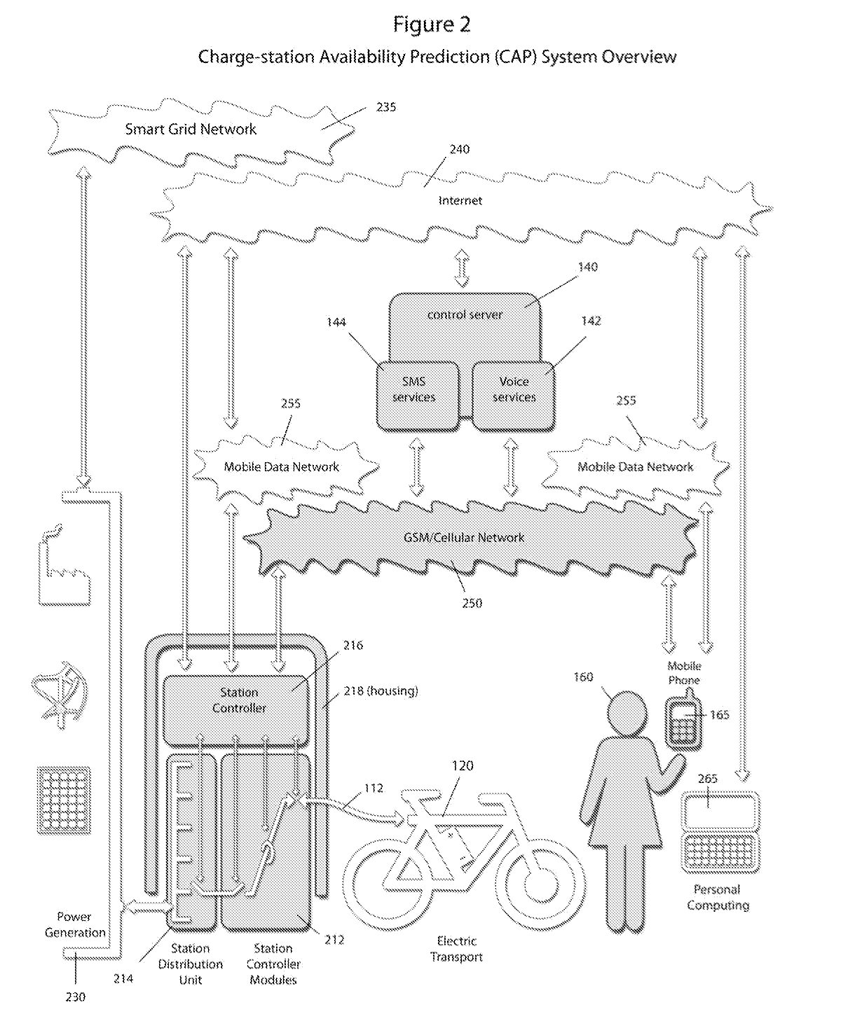

FIG. 2 illustrates a specific exemplary embodiment of a CAP system of FIG. 1. User 160 plugs 112 her vehicle 220 into charging station 210 which provides one or more station modules or plugs 214. Power is supplied to plugs 212 through power distribution unit 214 which is in electrical communication with an external power supply 230 such as a municipal power grid. Power supply 230 is connected to, in specific embodiments, to a smart grid network 235. Station 210 also houses 218 controller station 216 which communicates with power distribution unit 214 and plug modules 212.

Station controller 216 may communicate with user 160 and her phone 165 or laptop or tablet computer 265 via any one of the various communication modalities that may be available, such as the internet 240 or GSM/Cellular telephone network 250. Station controller 216 communicates with control server 140 via the internet 240 or the telephone system 250, depending on the local communication configuration or the specific embodiment of the CAP system.

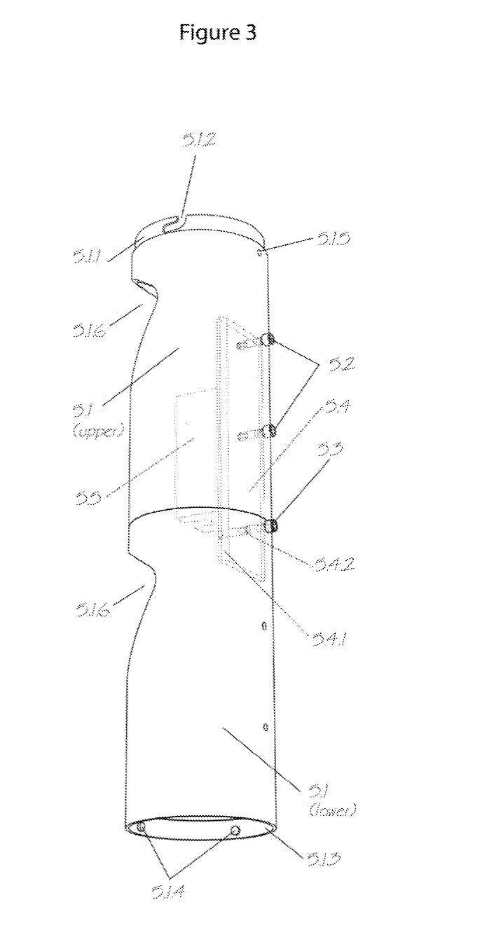

FIG. 3 is a transparent side view of a specific exemplary embodiment of an assembled charging station of the present disclosure. Upper and lower housing units 5.1 are concatenated and secured together with short pins 5.2 and long pin 5.3, which pins also secure spine plate 5.4 in position inside the housing. Plate 5.4 retains electrical components 5.5. Plate 5.4 is held securely against the walls of the housing units 5.1, which advantageously wicks heat from electrical components 5.5 to the external environment via the housing itself.

Fully assembled mode is when 2 or more module housings 5.1 are twisted locked together and upper module short spine bolts 5.2 plus lower module long spine bolt 5.3 are in place. These bolts are placed through their respective housing's spine bolt holes 5.1.5 and screwed into the upper module spine plate 5.4. The bolts firmly lock the two modules together while holding the modules contents and providing an opportunity for tensioning support for each module's User Safety Physical Interface Assembly 5.6. The bolts also force the spine plate 5.4 to contact the inner wall of the tubular housing 5.1 with great pressure, forming an effective heat exchange area for heat dispersion from the module's electrical components (5.5.1) to the outer surface of the station, as described below.

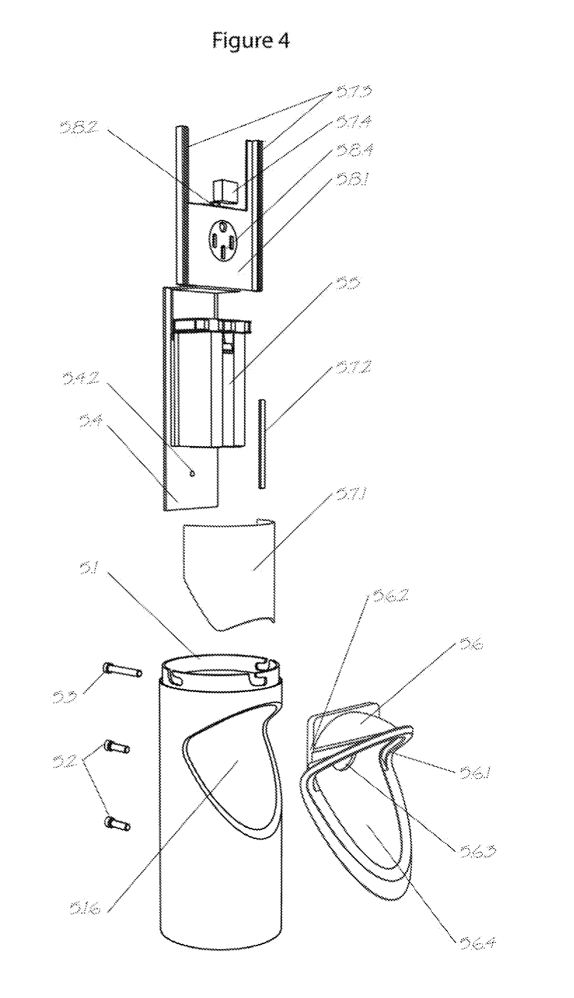

FIG. 4 is an exploded front view of a user interface of a charging station of the present disclosure. This assembly provided a safe physical interface with which the user connects their vehicle for charging. It consists of a one piece face cover (5.6) a shield (5.7.1), front shield slider (5.7.2), rear shield sliders (5.7.3), shield controller assembly (5.7.4), receptacle bracket (5.8.2), receptacle tensioned assembly (5.8.3), an outlet receptacle (5.8.1) and in some modules a cable assembly (5.9). One piece face cover 5.6 mounts to cut away aperture 5.1.6. Slidably mounted shield 5.7.1 is disposed within the housing so as to optionally shield face cover 5.6 from the external elements. One or more slider rail 5.7.2 slidably mates with rear sliders 5.7.3. All of the internal parts of a module are assembled and fastened to the spine plate 5.4. This entire assembly slides down into the tubular housing 5.1 and is fastened from the rear using the spine bolts. The One Piece Face Cover 5.6 is then inserted into the front opening 5.1.6 and fastened internally to the receptacle bracket 5.8.2. This allows the station to have no exposed fasteners.

Physical electrical connection sensors are provided for the electrical outlets 5.8.1 whereby the station cables and outlets remain in a default powered off state for safety. For example, a plastic wedged-shaped sliding part and two conductive spring metal parts held in a molded plastic housing so that the large spring pushes the plastic slide part into the path of the insert able plug prong. When a plug is inserted the prong forces the plastic sideways compressing the larger spring until it contacts the smaller spring thus closing a low voltage electrical circuit. This circuit tells the station controller that a user has physically connected the current carrying conductors from the station to the electric vehicle. The station controller can then allow high voltage power to flow more safely through the prongs and said conductors.

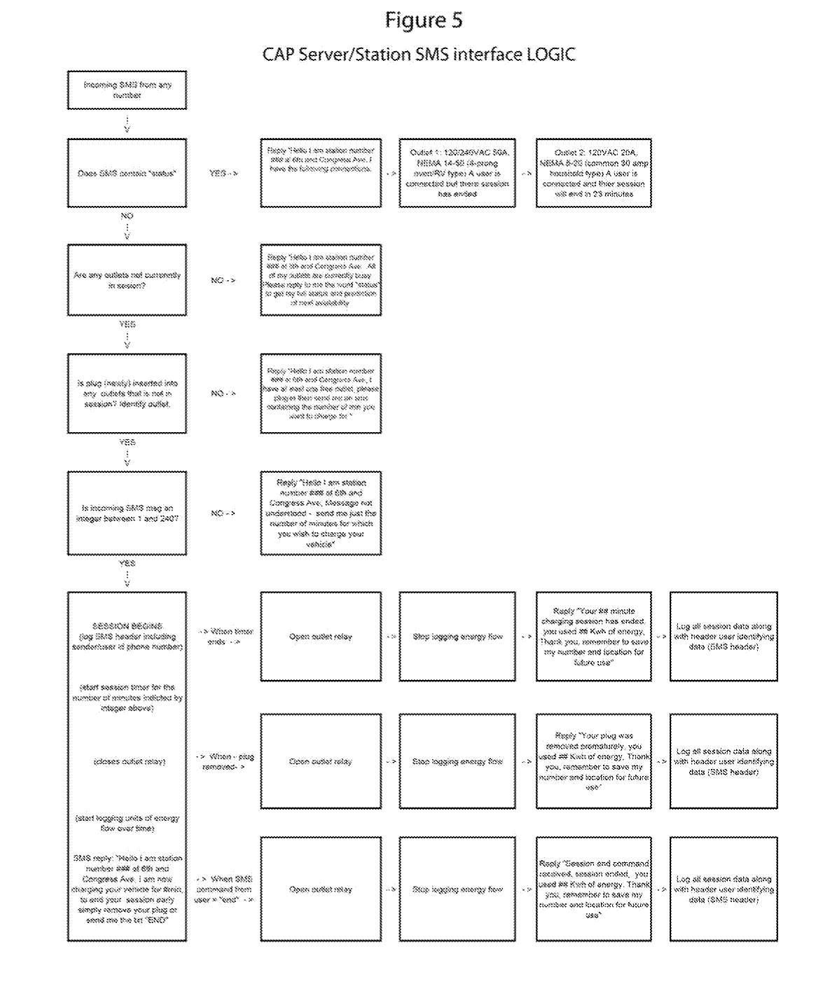

FIG. 5 is an exemplary embodiment of a process flow diagram for an SMS interface of a CAP system of the embodiment of FIG. 1. Through simple SMS queries (from user) and responses (from Server/station), the user can predict the availability of a given charging station. Once connected to a station the same interface allows the user to begin their charge session and set its duration.

Starting with the upper right of the flow diagram, a charging station receives an SMS or text message from a phone number. If the SMS message contains a “status” query, then the process tracks to the right of the flow to reply to the originating phone number with status information for the station's connections.

If the incoming SMS message does not contain a “status” query, the process flow tracks down the left side of the diagram. The station either replies with instructions for obtaining more status information or proceeds to determine whether an outlet is available for charging, the duration of the charging session and so forth, and replies to the originating phone number with an appropriate text message.

The lower portion of FIG. 5 illustrates the SMS messaging process during a charging session. When a session starts, the station electronically opens an outlet (the protective cover pops open, for example, providing access to the plug outlet) and starts the flow of electricity to charge the vehicle. A session ends when the requested time has, elapsed (the station turns off the power to the oulet), when the user unplugs the vehicle before the designated time has expired, or when the station receives an “end” command by SMS reply.

In a preferred embodiment, and as will be described in more detail below in Embodiment 2, the user is a subscribing customer with an wireless card or key chain stick, such as, for example, RFID, which communicates to the station the customer's account information, including the customer's mobile phone number. The station has a receiver and microprocessor to receive the wireless information and through the server/and or cellular network to send an SMS message to the customer's phone to verify the customer's account and charging request.

An alternative or additional embodiment provides a telephony interface for the user. This alternative CAP interface, through simple voice queries (from user) and pre-recorded or simulated voice responses (from Server/station), the user can predict the availability of a given charging station. Once connected to a station the same interface allows the user to begin their charge session and set its duration.

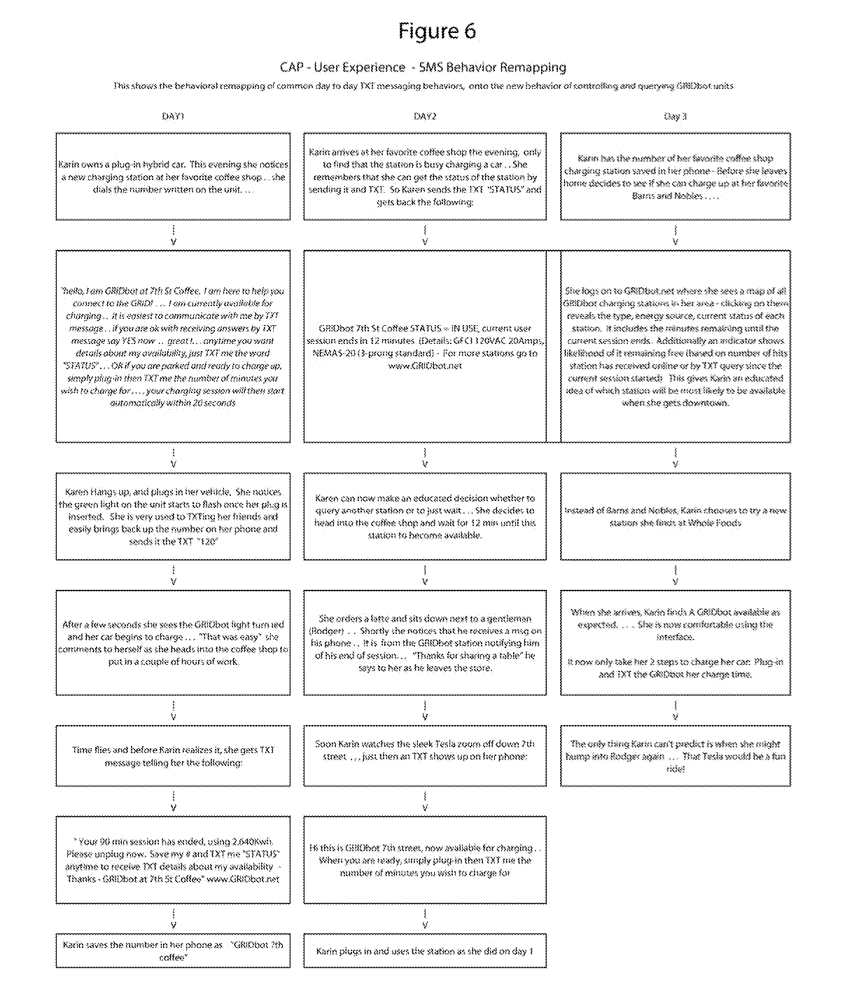

FIG. 6 is a process flow diagram of SMS behavior remapping for an exemplary embodiment of a CAP system of the present disclosure. The diagram illustrates how use common texting behavior can be remapped to text with the charging station SMS interface. Starting on the left of the diagram at Day 1 and moving down the process flow, a user, Karin, finds a charging station at a coffee sharp and she send a text message to the number she finds posted on the charging unit. The unit replies with instructions for how to charge your car and how to communicate with the station with text messages. Karin programs the station via text message to charge her plug-in vehicle for a certain number of minutes. She notices the station illuminates a green light when it is available for charging and then illuminates a red light when the station is actively charging her vehicle, and then she goes off to work. When the charging session is over she receives a text message from the station informing her so and giving her instructions for how to save the stations contact information for future reference.

The middle column of FIG. 6 illustrates another usage scenario, Day 2. Karin arrives at her coffee shop charging unit only to find that it is charging someone else's vehicle. She sends the txt message “status” to the unit and receives a reply back that the unit is busy but will be free in 12 minutes. She gets a latte and 12 minutes later receives a text message from the station telling her that the station is now available.

On Day 3, Karin logs onto a website for the charging stations to see if there is a station near her neighborhood book store. The website shows her a map of all the stations in her area. The website also shows the status of each unit, such as when the station at her bookstore will be available. The website provides her with an estimate of how long the station may remain free based on the number of inquiry pings the station is receiving.

### Embodiment 2

FIGS. 1-6, above, describe a specific embodiment in which a user initiates a charging session by contacting the station by mobile device with a telephone number provided by the station. The station's telephone number may be displayed by or mounted on the station, together with instructions for a user to text the station's number via SMS to begin an SMS dialog to initiate a charging session or to engage the CAP system.

### Alternative Embodiment

The disclosure now turns its attention to an alternative embodiment in which a charging or CAPs session is initiated differently. Also described are certain advantageous features of the electronics of a charging station of the present disclosure.

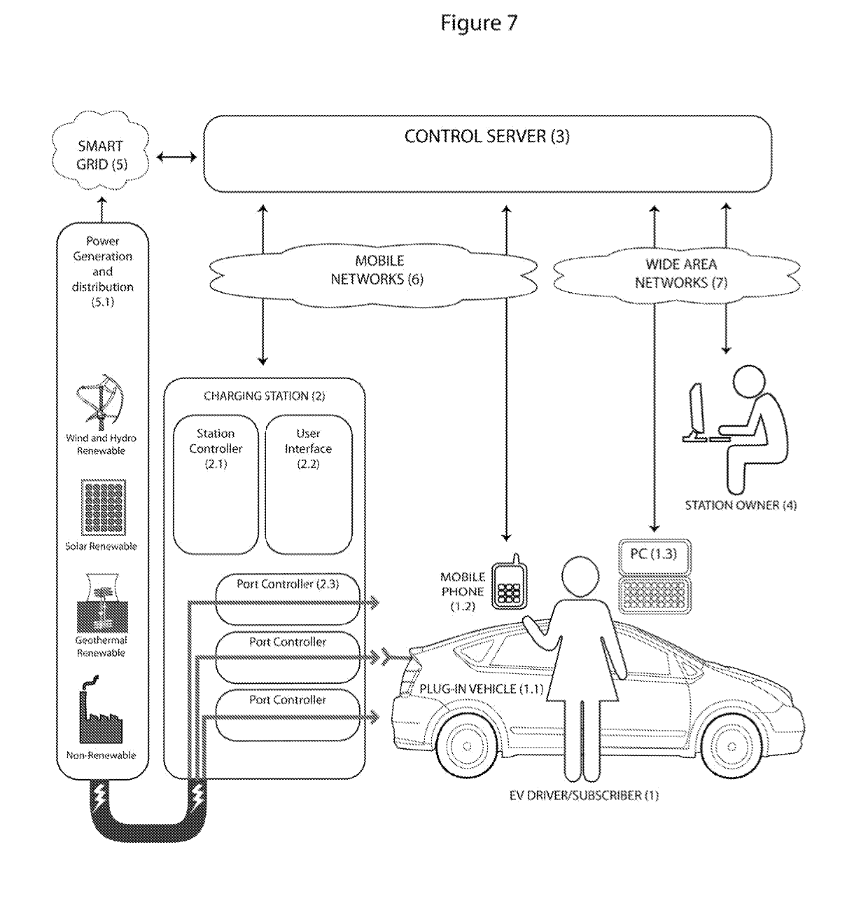

FIG. 7 is a diagrammatic illustration of an exemplary alternative embodiment of a charging station system and CAP system of the present disclosure. Station (2) periodically contacts the server (3) through the mobile data network (6) (referred to as “calling home”. In response to this communication, the server (3) then sends configuration data to the station (2) including what price to display for each of its charging ports (2.3), what each port's maximum amperage limit is, and how often the station is to call home (call home interval).

The Station (2) displays the status if each of its charging ports (2.3), including availability, price and amperage limits on the Station User Interface (2.2). This interface also displays instructions, for an EV User to select a charging port, choose an amount of time they want to occupy charge port (along with its associated parking space), and to identify themselves to the system.

A EV user identifies themself to the system using their mobile phone number (1.2). This is done by entering their number at the Station User Interface (2.2). Alternatively by holding a wireless ID device containing their unique ID number near the wireless ID receiver device on the Station. Alternatively by SMS messaging the station's unique number from their mobile phone. Alternatively by calling station's unique number from their mobile phone.

The station controller (2.1) receives this information from the interface (2.2), and delivers the requested session data to, the server (3). The station controller (2.1) also commands the selected station port controller to unlock and turn on its flashing LED indicator light. Instructions are then displayed on the Station User Interface (2.2) telling the EV User (1) to physical connect their EV (1.1) to the charging port that is identified by the flashing LED.

If the port type allows for vehicle communication, the port controller handshakes with the EV, communicating its maximum amperage limit to the EV. Then closes its main switches, delivering energy to the EV. A charging session is now in progress. While in progress the station displays the status of the occupied charging port and shows the time that port will next be available. At any time, if the station is told by the server to change its amperage limit, the port controller handshakes with the EV requiring it to adjust its maximum allowable amperage draw accordingly.

If the port type does not allow for vehicle communication, it senses the EV is connected through, a combination of infra-red beam break plug sensor, and door sensor, and closes its main switches, delivering energy to the EV

When the server receives the user mobile phone number along with their requested session information, it compares the mobile phone number with those already in its database of users. If the user is already a “valid subscriber” in the system, the server stores the session information. If the users is not a “valid subscriber,” the server stores the mobile phone number in the database as a “trial user” and sends the user an SMS asking them to accept the terms of trial use of the system.

Example challenge response SMS to user: “ . . . station has received a request to charge your EV at <location>, price $X/hr, time Xhrs, to accept reply YES . . . , X free trials remain.”

If the user replies YES to the challenge response, SMS message, the session continues for the requested time.

If the user does not reply YES within a certain number of minutes, the server issues a shutdown command for the respective station port. When the station contacts the server next, it receives the session shutdown command and ends the charging session. The user may also end their session early by sending and SMS message, by identifying themselves at the station interface or by physical disconnecting their EV. If none of the above scenarios end the charging session, it will end automatically when the requested session time runs out.

In any case, upon session end, the port controller opens its main switch ending energy flow to the EV, the station resets its display to show port availability, and sends a “session end data file” to the server which includes the user phone number, the actual time the session lasted, the price displayed at the beginning of the session, the reason the session ended, and the number of KwH of energy drawn through the port controller during the session.

Upon receipt of the “session end data file” from a station, the server stores the data and sends a session end SMS to the user notifying them that the session ended, the reason, the time elapsed, and the session charges if applicable.

Example session end SMS to user: “your . . . EV charging session has ended, <reason>, session time=Xhrs, charges=$X, thanks you for using . . . station, X free trial remain, log onto_server to create your account”

Charge Availability Prediction:

The server stores the status of each station port, on the entire network, in the database. This including the session time remaining for any charging port in use. When any other EV driver who is looking for an available station contacts the server, (through an internet browser or the smart phone application) they are offered a list and map of stations on the network.

This system allows the user not only to see the location of each port and whether or not it is occupied, but also to see the predicted time the station will become available based on the requested session time of the user currently using the station. And based on the number of quieries each as station is getting from other users, the approximate amount of time the station may stay unoccupied. Thus offering EV drivers the Charge Availability Prediction Feature of this invention.

Energy Management (Curtailment Activities):

From time to time it is of value to a provider or retailer supplying electrical energy to a given area, to have the ability to slow down the draw of electrical energy in that area. This becomes important when the energy demand or load, becomes higher than what the utility can supply to that area and there a risk arises of the line voltage dropping causing a blackout or brownout. Utilities have 2 options in these scenarios: 1) they can buy more energy from another provider usually at an elevated price, or 2) they can pay someone in the area to not draw as much energy until the problem subsides. The latter is known as a load “curtailment activity” or “demand response”. Such curtailment activities have a distinct monetary value.

Because the server regularly sets each station port's total amperage limit (communicated to the EV through the pilot wires as part of a standard EV charging protocol) the system can create an effective curtailment activity in any area that has a significant number of charging sessions. The server algorithm selects station ports with EV connected in a given area, adds up the total energy being drawn by those EVs and offers to the utility a measurable curtailment activity that involves turning down the amperage limits by a certain percentage or signaling to capable vehicles to reverse energy flow thus back feeding energy back into the grid.

Some renewable energy sources such as wind and tidal are particularly subject to large fluctuations in the amount of energy they can supply. The system of this disclosure in conjunction with large number of electric vehicles has the potential to draw and store large amounts of energy while creating on demand curtailment activities large enough to balance out wind and tidal fluctuations.

Methods for Load Curtailment Activities:

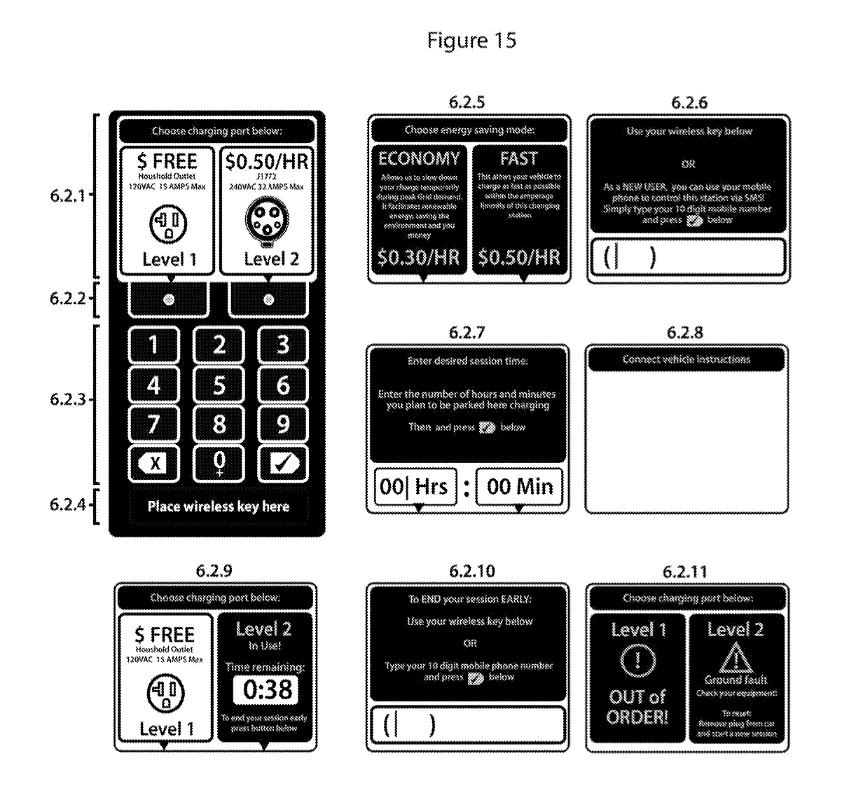

The server sets maximum load (amperage) limits, as well as economy load limits of each charging port on the network, depending on user choices made on the interface (FIG. 15 6.2.5), an amperage limit is communicated by the port controller to any vehicles following the standardized protocol (SAE J1772 level-2 and higher protocol for EVs). Furthermore the server may change these load limits for any port or group of ports from time to time. When curtailment activity is available the charging station or port executes the activity in various ways depending on the local circumstances.

Additionally, when a vehicle is connected to the network, its charging port regularly reports to the server, the actual load (amperage) being drawn by the vehicle in addition to the amount of time that vehicle is expected to remain connected (user requested session time). This information is logged in memory on the station as well as being logged in the server database.

Requested Curtailments:

When it becomes desirable to reduce the load on the electrical grid in a given area the energy providing party or power provider, which may also include intermediates or brokers, may make a request to the system for a curtailment of the loads in that area for a certain time. Alternatively, the charging station or port may offer to the power provider a curtailment activity on it own initiative from the data it is seeing in the system. To determine the load level, the system then mines the load limit data, the actual load data, users economy setting (as set on the interface as well as the expected duration of that actual load, and offers back to the requesting entity a quantifiable curtailment activity in terms of wattage over a the set time. If the offer is accepted, the server adjusts the limit settings for the charging ports in that area accordingly. Each vehicle in turn lowers its load effect (amperage) according to the standard protocol.

Automatic Curtailments:

Furthermore each port controller is equipped with hardware and software that sense and logs data about local grid line conditions such as Voltage and AC frequency. By looking for unusual changes in this data, an algorithm in the system anticipates and estimates the “local stress level” on grid infrastructure (such as the local transformer). Using this “local stress level”, each charging port can also be set to automatically reduce its amperage limits as agreed upon by energy providing party and the consuming parties (EV users) according to “economy” or “fast” modes the user selects on the interface (6.2.5))).

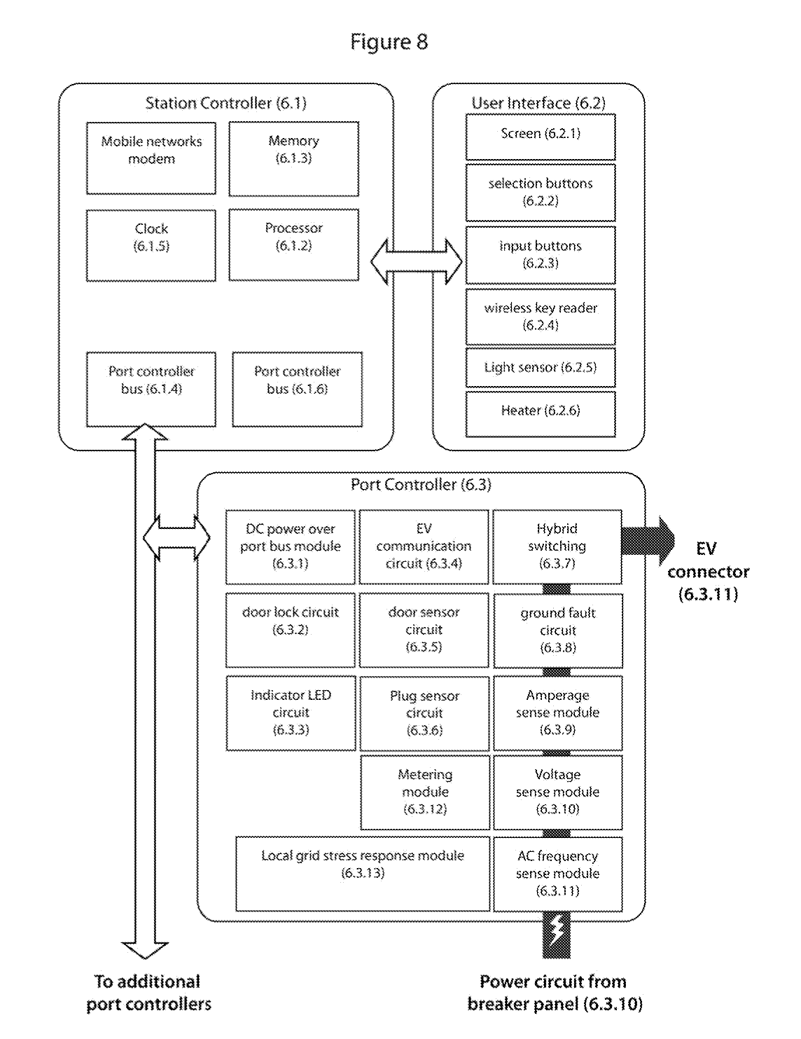

FIG. 8 is a diagrammatic illustration of the components of an exemplary embodiment of a station of the present disclosure. A Station (2.0) include a station controller (6.1) that communicates with a user interface (6.2) and provides a port controller bus (6.1.4) for communication with multiple port controllers (6.3).

The station controller (6.1) includes a mobile modem (6.1.1) for communication with the server; a processor (6.1.2); memory (6.1.3); a crystal clock (6.1.5), a TCP IP networking module (6.1.6) that allows multiple charging stations to be networked together using standard commercial cabling and hardware reducing cost and increasing network fault tolerance; and a port controller bus that caries communication and power to and from port controllers (6.1.4).

The User interface (6.2) includes a screen (6.2.1) for displaying options and information to users, selection buttons (6.2.2) for users to select between options, input buttons (6.2.3) for users to input alpha numeric data, a wireless key reader (6.2.4) that wirelessly reads the ID data from a small coded card or plastic key carried by the user, Light sensor (6.2.5) that facilitates logic that adjusts the screen and LEDs in the station according to ambient conditions, and a heater (6.2.6) that heats up the screen when ambient temperature drops below minimum operating temperature of the screen.

Each port controller (6.3) includes a DC power over communications bus module (6.3.1), a door locking circuit (6.3.2), an indicator LED circuit (6.3.8) that drives RGB LEDs used to provide wide range of colors that indicate status of charging ports to users from a distance, an EV communication circuit (6.3.4) utilizing pilots wires that handshake with the EV and communicates the amperage limits of the station as part of the defined SAE J1772 standard for EV charging communication in North America, a station door sensor circuit (6.3.5), a plug/EV connector sensor circuit (6.3.6), hybrid switching circuit (6.3.7), a hardware ground fault circuit (6.3.8), an amperage sense module (6.3.9), a voltage sense module (6.3.10), an AC frequency sense module (6.3.11), and a metering module (6.3.12) comprising of hardware and software that calculate power being consumed by the EV, and a local grid stress response module.

(6.3.13) that monitors voltage and frequency readings from other modules and uses this data to respond to unusual readings that may indicate stress on local grid systems such as transformers. This module may be programmed to reduce the allowable amperage limit to the vehicle when grid stress conditions are present.

The port controller senses the EV is connected through a combination of plug sensor, door closed sensor and or pilot wire handshaking depending on the type of connecting plug and receptacle.

Each port controller is connected to dedicated power circuit (6.3.10) from the breaker panel. This power circuit passes though the amperage, voltage, frequency, ground fault, and hybrid switching devices on the port controller before it reaches to the EV connector (6.3.11).

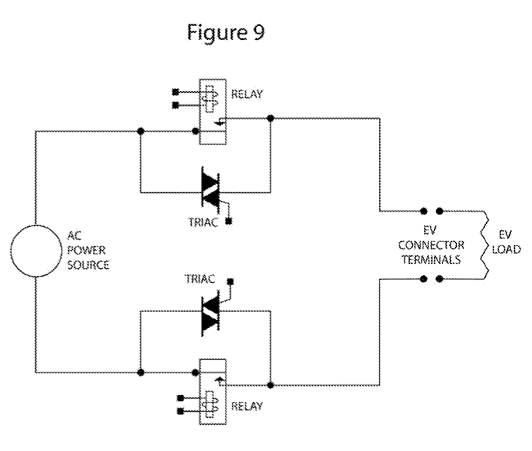

FIG. 9 is circuit diagrams of an exemplary embodiment of a hybrid switching circuit of a station of the present disclosure. This hybrid switching scheme for EV charging stations employs a solid-state switching device in parallel with relay contacts to extend the life of the relay and minimize power dissipation. This technique leverages the benefits of each device: the solid-state switching device attenuates arcing on relay contacts and the relay provides very low on resistance, which minimizes power dissipation.

Opening and closing the relay contacts causes arcing between the terminals which erodes the terminals and reduces the life of the relay. Using a solid state switching device in parallel with the relay allows zero current switching and reduces or attenuates arcing by reducing the voltage across the relay contacts.

To turn on the load, the solid state switching device is turned on first and then the relay contacts are closed. To turn off the load, the relay contacts are opened first and then the solid state switching device is turned off. The embodiment below shows hybrid switching using a triac as the solid state switching device, although other suitable solid state devices are contemplated by the present disclosure.

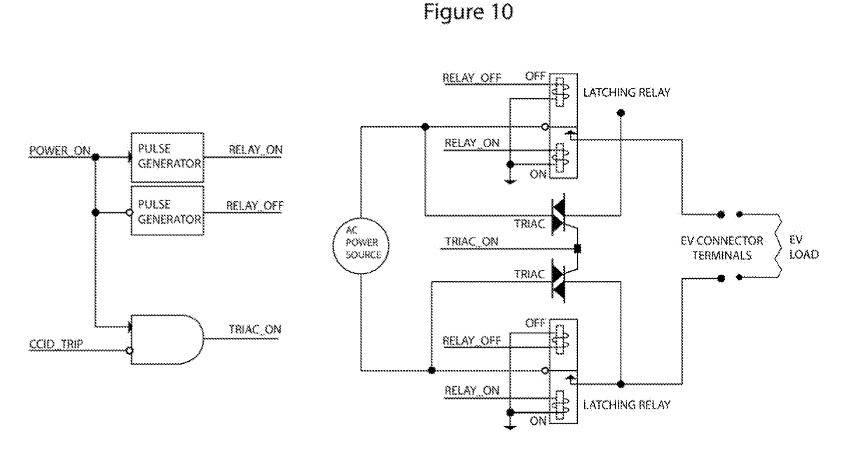

FIG. 10 is a circuit diagram of an exemplary embodiment of a fast hybrid switching circuit of a station of the present disclosure. In particular, FIG. 10 illustrates hybrid switching with a latching relay driver. The hybrid switching circuit of FIG. 10 is an enhanced embodiment over that of FIG. 9 that also provides a method for opening the circuit very quickly in the event of a ground fault by turning off the triac and opening the relay contacts at the same time. This embodiment also provides low power consumption by using latching relays that only consume power when changing state rather than standard relays that must be energized to hold the circuit in the on state.

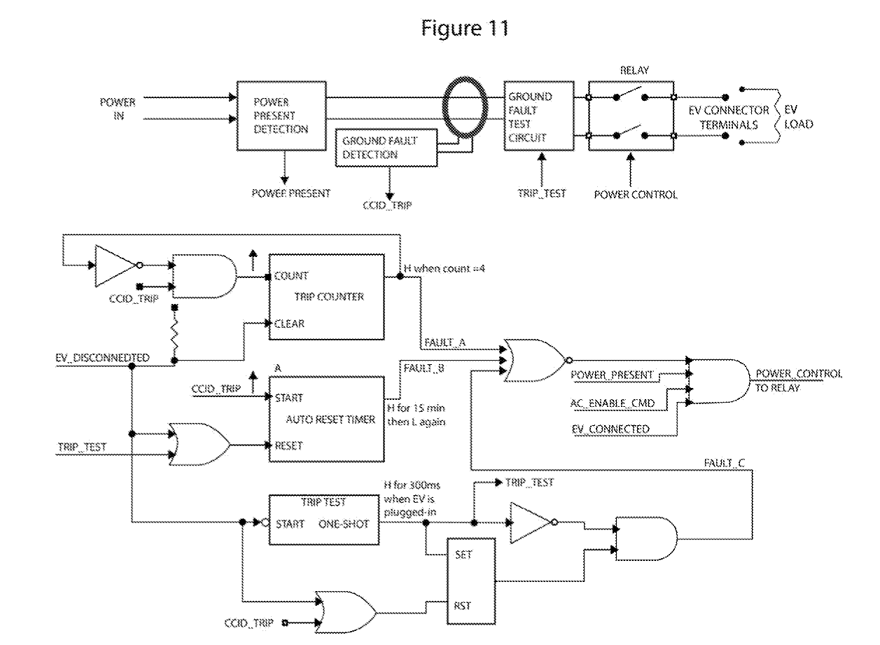

FIG. 11 is a circuit diagram of an alternative safety circuit of the present disclosure. In particular, FIG. 11 illustrates a hardware CCID20 Circuit. The embodiment of FIG. 11 illustrates a scheme that allows ground fault testing to be performed on the supply equipment before turning on power to the EV. A hardware implementation of a safety circuit requires less regulatory oversight than an equivalent implementation that uses software. This circuit provides logic, timing, and counting functions to monitor and test a ground fault interrupt circuit for an EV Charging Station.

A typical ground fault detection circuit using a current sense transformer is employed to detect when the current flowing out and back are not equal, which indicates an alternate current path has been established. A second winding on the current sense transformer allows detection of grounded neutral conductor by sensing the impedance change on the sense winding when the neutral conductor has a parallel path outside the sense transformer.

The circuit is divided into three sections with each section having a unique role in the fault detection scheme. The Fault B circuit is used to interrupt power to the EV when a ground fault is detected and provides automatic reset of the circuit 15 minutes later. The Fault A circuit is used to count the number of ground faults that have been detected. This allows automatic reset after 15 minute delay for only the first three ground faults. If a fourth ground fault is detected, the circuit will interrupt power until the EV is disconnected. The Fault C section of the circuit provides a self-test of the ground fault circuit upon connection of an EV to the charging station. Only after the ground fault circuit operation has been verified will power be applied to the EV.

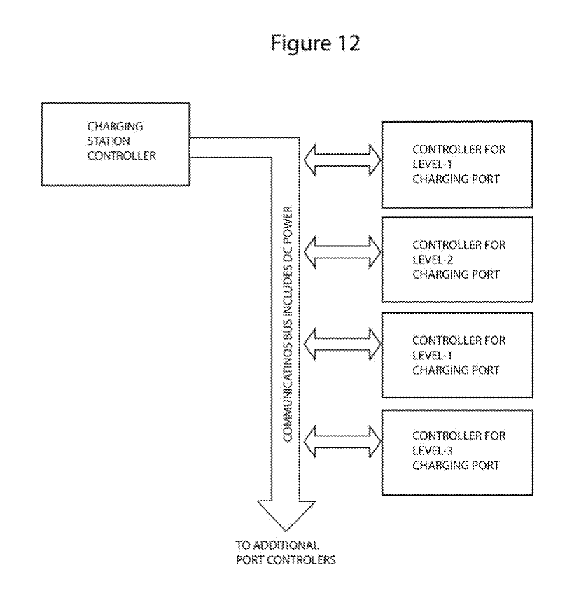

FIG. 12 is a diagrammatic illustration of an exemplary Modular Charging Port Scheme of the present disclosure. The modular charging port scheme for EV charging stations uses a multi-drop data bus and distributed power to form a flexible network of charging ports. One or more, charging ports may be connected to the bus without regard to the type of charging port that it can support.

This scheme allows the use of one user interface to support multiple charging ports. The station controller has the user interface (typically a display and keypad) and also has a data interface to a remote server database that keeps track of user accounts and usage information.

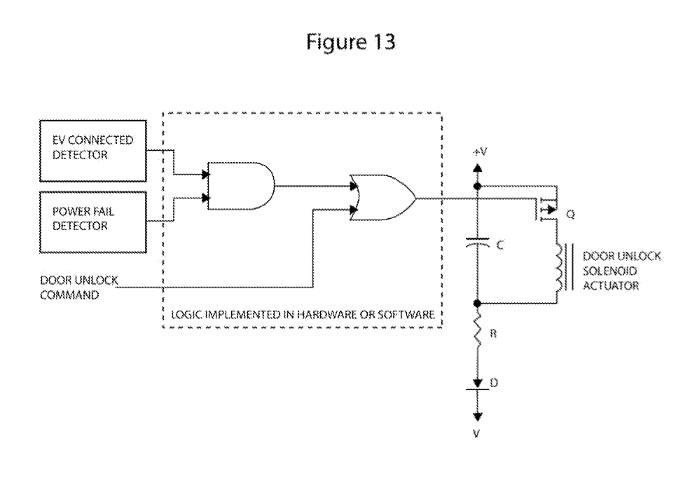

FIG. 13 is a circuit diagram of an exemplary embodiment of a door locking circuit for a charging module of the present disclosure. EV charging stations may require a locking door that restricts unauthorized access to a charging port outlet and closes over the EV charging cord during a charging session preventing unauthorized persons from unplugging an EV that is charging. In a power failure situation, a user must wait until power is restored before they can unplug their EV and drive away. Additionally, it is undesirable for the door to open during a power failure when an EV is not plugged into the station.

In addition to providing normal door unlock functionality required when a user is granted access, this solution automatically opens the door when power to the charging station is lost while an EV is plugged in. The door will not open unless an EV is plugged in.

The door mechanism is spring loaded such that when the door unlock solenoid is energized, the door will open. The circuit stores sufficient electrical energy to energize the solenoid after a power failure has been detected. A sensor or circuit is used to detect when an EV is plugged in to the charging port. Another circuit detects the power fail condition. Logic implemented in either hardware or software determines when an EV is plugged in and the power fails and energizes the solenoid.

Additionally, this circuit is energy efficient since the solenoid is only energized briefly when the door is to be unlocked and only consumes power when recharging after an unlock event.

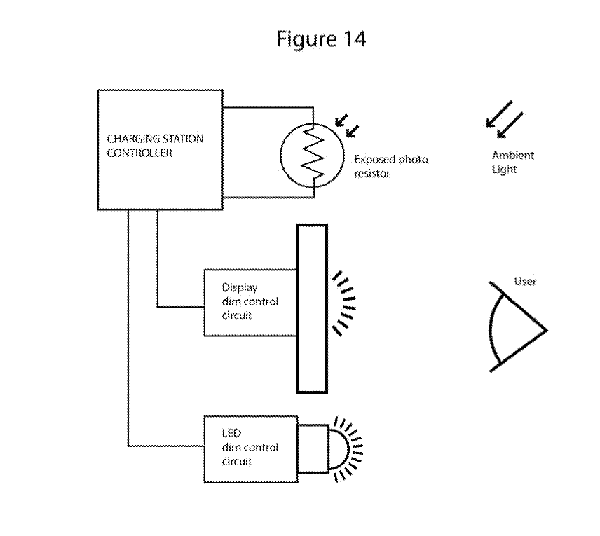

FIG. 14 is a diagrammatic illustration of an automatic dimming feature for a user interface of the present disclosure. It is desirable that charging station interface screens and indicator lights are readable in direct sun light as well as at night. Displays and indicator lights bright enough to be read in daylight become much too bright at night. This sensor circuit uses a photo resistor and software that tells the station display and LED indicators to be as bright as possible during bright day light, then dims them when ambient light drops so as not to blind the user at night when, their eyes have become more sensitive.

FIG. 15 is a diagrammatic illustration of a station user interface of a charging station of the present disclosure. This embodiment of a station user interface includes a digital display 6.2.1, buttons to select between options 6.2.2, buttons for the user to input numbers 6.2.3, and a sign 6.2.4 indicating where the user is to pace their wireless ID key.

A series of query screens are presented for the user to complete. The initial screen 6.2.1 asks the user to select one of the available charging ports while offering details about the price, port type and electrical limitations of each available port. Once the user selects a port the next screen is displayed. Screen 6.2.5 offers a user fast or economy modes and may offer a discounted rate. Selecting “economy” allows the station to communicate to a compliant EV, through standardized pilot wires, to slow down or reverse energy flow to the EV temporarily during moments of peak demand on the local electrical grid. This is useful in that it allows the system to sell electrical energy curtailment or storage products to an energy provider who seeks to level peaks in load demand and peaks in excess production. Screen 6.2.6 asks the user to identify themselves to the system by either placing an issued wireless key near the signed area 6.2.4, or by entering their mobile phone number on the keypad 6.2.3. Screen 6.2.7 asks the user to enter the amount of time they intend to be using the charging port and occupy its associated parking real estate. Screen 6.2.8 instructs the user to connect their plug-in vehicle giving them step by step instructions depending on the type of charging port they have selected on screen 6.2.1. Once the connection with the vehicle is sensed by the station, the charging begins and screen 6.2.9 displayed showing the status and time remaining charging session while offering other users the choice to select other available ports if present. Screen 6.2.9 also offers the current session user the option to end their session early. Selecting the “end session early option” on screen 6.2.9 brings the user to screen 6.2.10 where they are required to identify themselves to the system by the same means used to start their session on screen 6.2.6. The following events end a session and return the interface back to screen 6.2.1: a) the end of the session timer, b) user disconnects the vehicle, or c) user successfully completes screen 6.2.10. When things go wrong with a charging session or if one of the ports is out of order, elements of screen 6.2.11 may be displayed in conjunction with elements of screen 6.2.1 or 6.2.9.

Each station may be configured from the server to have certain default settings allowing the interface to omit screens that are not applicable at the particular site installation (for example the stations that are for the sole purpose of charging a private fleet of vehicles may have a default energy savings setting so the user would not have to complete screen 6.2.5.

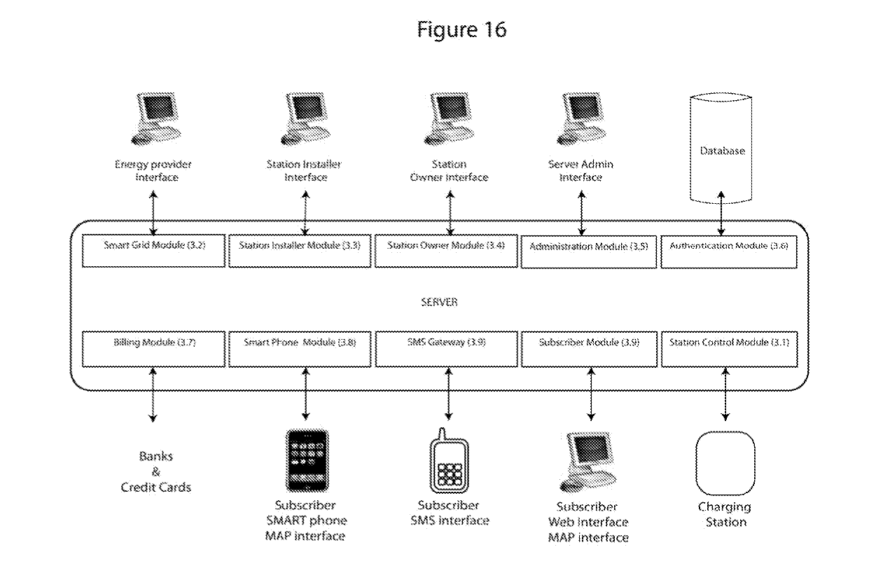

FIG. 16 is a diagrammatic illustration of various modules for a CAP system of the present disclosure. A Station Control Module (3.1) receives session user number/ID, minutes requested, end times, KwH used, price displayed from stations, and responds by sending control and configuration data to station including: price settings, call home interval time, max amperage, shut off commands. Additionally this module prepares and transmits boot load data to stations in order to replace station firmware.

A Smart Grid Module (3.2 receives curtailment requests from energy provider/retailers, searches the database for current charging sessions in a given area and calculates a curtailment offering based on station owner setting and subscriber preferences. The module then offers corresponding curtailment and storage services back to the energy provider/retailer.

A Station Installer Module (3.3) provides station installers provisioning tools to create new stations and groups of stations in the database. This module receives information from newly installed stations and creates database entries for the new ports offered by those the new stations recording the following data about each charging port: Station ownership, GPS location, street address, description of location, type of port, amperage rating, voltage rating, field wiring gauge, circuit breaker rating, ventilation at site, closest meter ID, local renewable energy, nearest supply transformer.

A Station Owner Module (3.4) provides station owners tools to manage and view historical metrics about stations they own. Facilitates viewing of filtered lists of each port or group of ports by location, address, transformer, meter, price, and usage and fault statistics. Furthermore this module offers stations owners tools to hierarchically set the following parameters on a per charging port or group of port basis. Settings include: fleet or vending mode, station interface options, station interface language, default price and amperage limits, overriding prices/Amp limits for various times of working days, overriding prices/Amp limits at various times of weekends and holidays, fault notification settings.

An Administration Module (3.5) provides administrative tools managing the server and all of its modules. Additionally provides queries to the database for data mining purposes.

A User Authentication Module (3.6) checks session request data against a database of subscribing users. Prepares SMS challenge response messages, automatically creating new user accounts accordingly.

A Billing Module (3.7) processes subscriber payments with various credit card and 3rd party payment system.

A Smart Phone Module (3.8) prepares subscriber account data for viewing in a smart phone application providing users with graphic tools to view details about current and historical charging sessions on their mobile device. Provides access to user notification settings, allowing them to receive SMS notifications about their charging sessions and changes in availability of stations they are interested in. Supports Smartphone map of stations on the network, showing groups of stations and charging port location, pricing, in-use status, and each time the port will next be available. Provides connectivity to the billing module executing one-time and recurring payments by the user and stores payment preferences.

An SMS Gateway (3.9) provides a resource to other server modules by facilitating the sending and receiving of SMS messages to a from various mobile network carriers.

Subscriber Module (3.9) prepares subscriber account data for viewing in a web browser, providing the user with graphic tools to view details about current and historical charging sessions. Provides access to user notification settings, allowing them to receive SMS notifications about their charging sessions and station availability. Supports browser map of stations on the network, showing groups or stations and each charging port location, pricing, in-use status, and the time the port will next be available. Provides connectivity to the billing module executing one-time and recurring payments by the user and storing payment preferences.

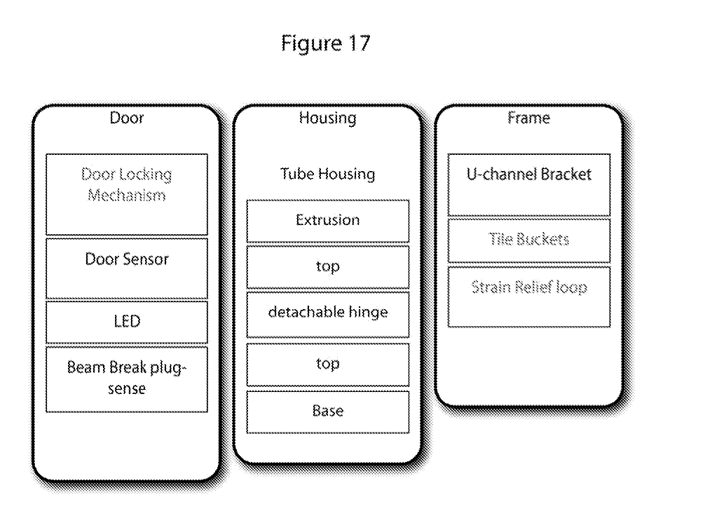

FIG. 17 is schematic diagram illustrating the physical components of an exemplary embodiment of a charging station of the present disclosure. Included among the components are: an extruded tubular housing, threaded mounting base coupler, and hinge receiving part, a strain relief loop, and a head unit. The head unit includes a u-channel frame, extruded rails, station lid, detachable hinge plate, modular overlapping charging ports, hinging door, door locking mechanism, door sensor, beam break plug sensor, and LED indicators.

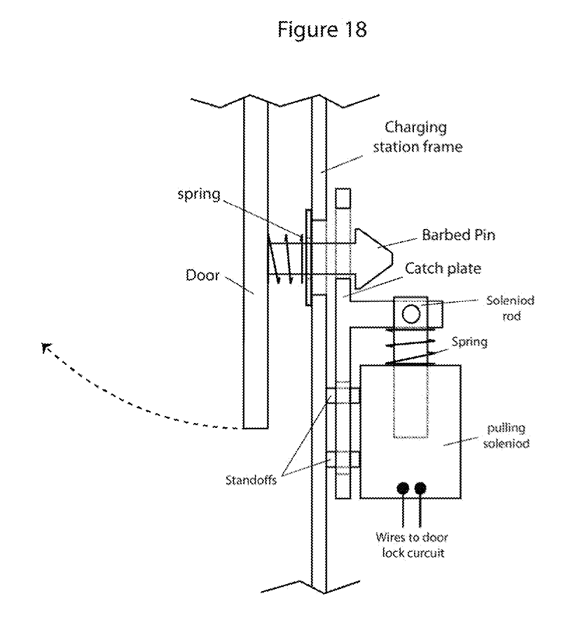

FIG. 18 is a side view illustration of an exemplary embodiment of a door locking mechanism of a charging station of the present disclosure. It is desirable that a door covering a charging port receptacle is kept locked while that is in use preventing removal by a third party of the users EV connection cord. The door locking mechanism comprises of a spring loaded pull solenoid that is mounted to the station with 2 or more standoffs. A catch plate is attached to the solenoid such that it is held in all direction except for the direction of the solenoid's pulling action. A barbed pin, is securely fastened to the door such that as the door is closed, the pin pushes the catch plate down, against the spring, until it passes the barb, at which time the catch plate springs back up behind the barb, stopping the pin from being pulled back. Thus locking the door. When a pulse of energy is sent to the solenoid, it pull the catch plate down allowing the door to spring open. The features of this mechanism are desirable in that the door can be opened with a relatively small amount of energy when the user is granted access to the port. All other times the door can be locked without expending any energy.

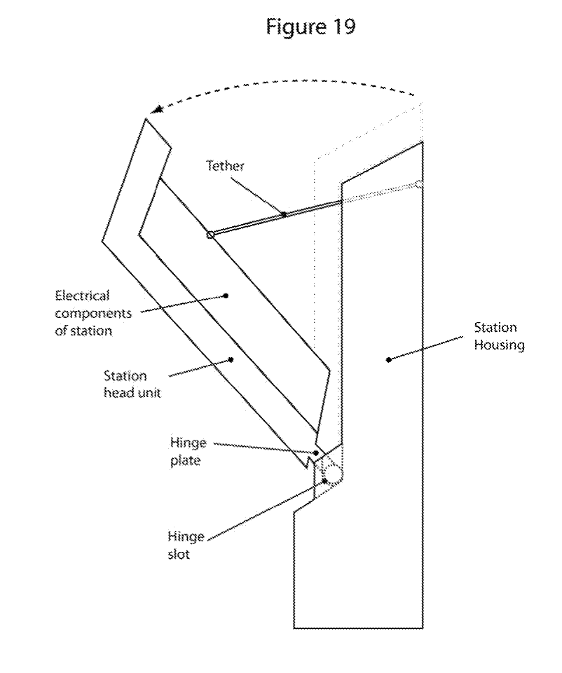

FIG. 19 is a side view illustration of an exemplary embodiment of a hinged housing access of a charging station of the present disclosure. Hinged access is advantageous for installation and service access into the station where the front of the station hinges open to allow easy and safe installer and service access to inspect and wire the unit in the field.

Charging stations must be connected, in the field, to the conductors coming from the breaker panel providing power to each charging port in the station. Hinged access is to these field connection terminal in the station is generally preferred for the initial field wiring process and subsequent inspection of field wiring connections. Furthermore, it is desirable that the heavier mechanical installation of foundation and housing of a station are completed first while the more delicate electronic and electrical insides of the station are installed last. The physical embodiment of a station provides a hinge plate with a rod attached to is, on the main head unit. The housing is installed first and field wiring is pulled into the housing. Main head unit is then inserted into the hinge slot on the station housing, once in place the main station head unit is free to hinge closed sealing against the housing. A tether keeps the hinge head unit from opening too far

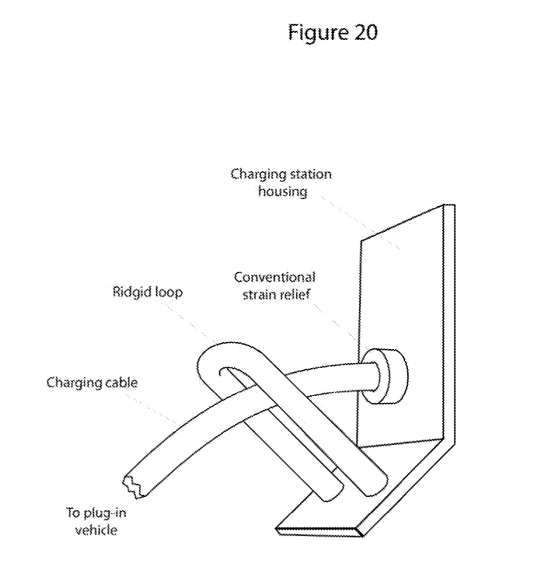

FIG. 20 is an illustration of a secondary cable strain relief device of a charging station of the present disclosure. A loop of ridged material such as metal, is used in conjunction with conventional electrical cable strain relief mechanism. The cable passes though the strain relief and then though the ridged loop that is bolted to the housing. The loop provides additional lateral and vertical strain relief for the cable. This allows for use of A less expensive conventional strain relief to be used.

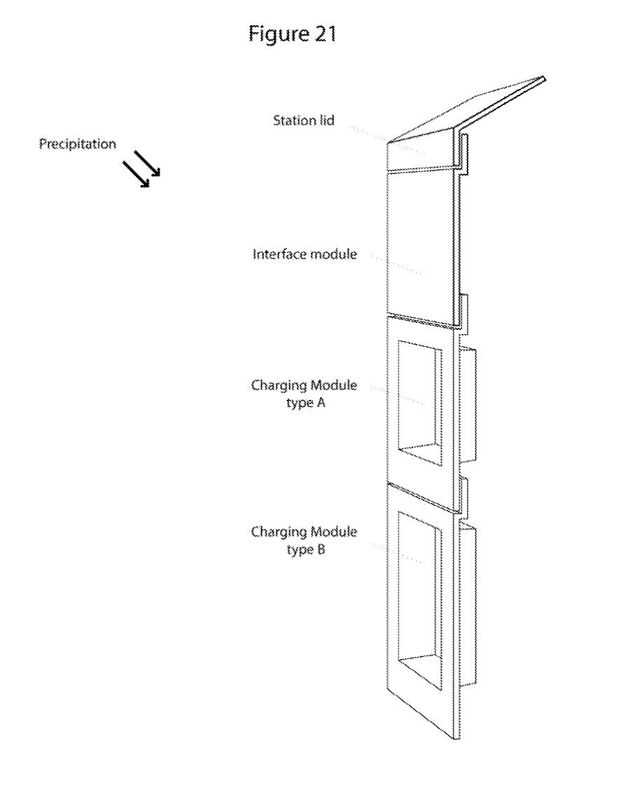

FIG. 21 is a side view illustration of modular scheme comprising tileable modules of a charging station of the present disclosure. It is desirable that a station is built so that precipitation runs off and is generally prevented from entering the station. The overlapping features at the top and bottom of each station module allow for stations to be built in different configurations using similar parts. One station may consist of 3 of module A and one of module B, while another may consist of an interface module and one of module B. Use of modular parts saves, costs associated with tooling and production of parts.

The Charge-Station Availability Prediction (“CAP”) system is a hardware/software combination is crucial to the CAP system. Interfaces with all of the components within a station and its sub modules, sensing, switching power on and off and logging data while communicating wirelessly to the main server and user mobile phone. Hardware comprises microcontroller, memory, crystal (clock), wireless communication, energy metering, acceleration sensors, temperature sensors, and power supply components. Software comprises communication protocols, parsing, logging, timing, energy metering, and interface challenge response algorithms.

In addition to the foregoing embodiments, the present disclosure provides programs stored on machine readable medium to operate computers and devices according to the principles of the present disclosure. Machine readable media include, but are not limited to, magnetic storage medium (e.g., hard disk drives, floppy disks, tape, etc.), optical storage (CD-ROMs, optical disks, etc.), and volatile and non-volatile memory devices (e.g., EEPROMs, ROMs, PROMs, RAMs, DRAMs, SRAMs, firmware, programmable logic, etc.). Furthermore, machine readable media include transmission media (network transmission line, wireless transmission media, signals propagating through space, radio waves, infrared signals, etc.) and server memories. Moreover, machine readable media includes many other types of memory too numerous for practical listing herein, existing and future types of media incorporating similar functionally as incorporate in the foregoing exemplary types of machine readable media, and any combinations thereof. The programs and applications stored on the machine readable media in turn include one or more machine executable instructions which are read by the various devices and executed. Each of these instructions causes the executing device to perform the functions coded or otherwise documented in it. Of course, the programs can take many different forms such as applications, operating systems, Perl scripts, JAVA applets, C programs, compilable (or compiled) programs, interpretable (or interpreted) programs, natural language programs, assembly language programs, higher order programs, embedded programs, and many other existing and future forms which provide similar functionality as the foregoing examples, and any combinations thereof.

In particular, the present disclosure contemplates software applications, sometimes colloquially called “apps” to enhance a users experience of the CAP system. For example the CAP Mobile Application is a software application which provides the user with real time availability prediction and location information, of various types of charging stations and their sources of energy. The Charge Monitoring Mobile App is a software application which provides the user with real time and historical statistics about their vehicle charging behavior and consumption or different type of renewable energy generation.

Many modifications and other embodiments of the charging station described herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A charging station for charging plug-in vehicles, the charging station comprising:
one or more charging modules connected to a power source;
a user interface to control the charging station with a communications terminal, and
an availability prediction system to communicate to a communications terminal when at least one of the charging modules will be available.

2. The charging station of claim 1, wherein the charging station is controlled with the communications terminal by text message.

3. The charging station of claim 1, wherein the charging station is controlled with the communications terminal by voice.

4. The charging station of claim 1 further comprising a housing having a cantilever hinge to selectively open the housing.

5. The charging station of claim 1 wherein the station is suitable for outdoor use.

6. The charging station of claim 1, wherein the station is connected to the Internet.

7. The charging station of claim 1, wherein the availability prediction system is accessible on an internet connected device.

8. The charging station of claim 1, wherein the availability prediction system comprises information that includes on or more of the following: (a) at least one of the charging modules is in use, (b) the time when the module in use will be available, and (c) a prediction of the length of time the module will be available.

9. The charging station of claim 1, further comprising an hybrid electrical switching system to attenuate the occurrence of arcing that reduce the life of the switch when a charging session is terminated.

10. The charging station of claim 1, wherein one or more of the charging modules comprises a power cord for plugging into a vehicle to charge the vehicle's batteries.

11. The charging station of claim 10, further comprising, mounted in front of the charging modules with a power cord, a rigid loop through which is threaded the power cord to reinforce the power cord against shear forces.

12. The charging station of claim 1, wherein one or more charging module comprises an automatically locking door.

13. The charging station of claim 12, wherein the module door automatically unlocks upon loss of electric current to the module.

14. The charging station of claim 1, further comprising an illuminated user interface, wherein the brightness of the illumination is responsive to the level of ambient light.

15. The charging station of claim 1, comprising at least two charging module tiles, wherein the modules are mounted in the station in a tiled manner to facilitate water run off.

16. A plug-in vehicle charging station system, the system comprising:
one or more charging stations;
a power source connected to one or more of the power stations;
a communication network connected to at least one of the charging stations;
at least one communication terminal in communication with at least one of the charging stations to control the charging station;
at least one control server connected to at least one of the charging stations and to a communication terminal to facilitate control of the of the charging station with the terminal; and
a charging station availability prediction system in communication with at least one of the terminals and the control server in communication with the terminal.

17. The system of claim 16, further comprising demand response to administer curtailment requests from the power source.

18. A method to predict the availability of a plug-in vehicle charging station charging module, the method comprising the following steps:
a. communicating with the charging station via a communications device;
b. obtaining from the charging station the status of each charging module;
c. for those modules that are in use, obtaining from the station a information of when each module in use will be available; and
d. for each notification of when each module will be available, obtaining from the charging station a prediction of the duration of time the module is likely to remain available.

19. The method of claim 18, wherein the step of communicating with the charging station comprises providing the station with the phone number of a mobile device to initiate, communication.

20. The method of claim 19, wherein the step of providing the station with a phone number comprising transmitting the phone number to the station wirelessly.

21. The method of claim 19 wherein the step of providing the station with a phone number comprises manually entering the phone number.

22. The method of claim 18, wherein the step of communicating with the charging station comprises calling a phone number provided by the station.

23. A charging station for charging plug-in vehicles, the station comprising:
a. one or more charging ports connected to a power source;
b. load shedding means to automatically adjust demand on the power source depending on power source conditions; and
c. hybrid switching to attenuate arcing and extend switch life.

24. A hybrid switch for a plug-in vehicle charging port, the switch comprising a solid state switch in parallel with a relay to attenuate electrical arcing and heat dissipation.

25. A method for load curtailment by a charging port in an electrical grid, the method comprising:
setting the range of load amperage limits of the charging port;
determining the load being drawn and expected to be drawn by a vehicle drawing amperage from the port;
determining the whether curtailment activity for the port is available; and
executing the curtailment activity.

26. The method of claim 25, wherein the electrical grid has a power provider, and wherein the method further comprises offering the curtailment activity to the power provider.

27. The method of claim 25, wherein the electrical grid has a power provider, and wherein the method further comprises offering the curtailment activity to the power provider in response to a request from the power provider.

26. The method of claim 25, wherein the curtailment activity is executed automatically when it is determined to be available.
